(19) United States
(12) Patent Application Publication
(10) Pub. No.: US 2010/0154214 A1
(43) Pub. Date: Jun. 24, 2010

(54) TURBINE WHEEL AND SHAFT JOINING PROCESSES

(75) Inventors: Christopher Hsu, Avon, OH (US); James W. Mumaw, Wadsworth, OH (US)

Correspondence Address: GIFFORD, KRASS, SPRINKLE,ANDERSON & CITKOWSKI, P.C, PO BOX 7021, TROY, MI, 48007-7021, US

(73) Assignee: Nelson Stud Welding, Inc., Elyria, OH (US)

(21) Appl. No.: 12/640,851

(22) Filed: Dec. 17, 2009

Related U.S. Application Data
(60) Provisional application No. 61/138,580, filed on Dec. 18, 2008.

(51) Int. Cl. B23P 11/00

(52) U.S. Cl. 29/889.21

(57) ABSTRACT

A process for joining a turbine wheel and a turbine shaft of a turbocharger comprising the steps of: providing a turbine wheel; providing a turbine shaft; holding the turbine shaft in a welding device; contacting the turbine shaft to the turbine wheel; energizing a pilot current; lifting the shaft a predetermined height from the turbine wheel to draw a pilot arc; energizing a weld arc current locally melting the shaft weld end and forming a weld pool on the wheel; plunging the shaft toward the wheel into the weld pool; turning off the current; and removing the welding device from the welded shaft.

### CROSS-REFERENCE TO RELATED APPLICATIONS

This application claims priority benefit of U.S. provisional patent application No. 61/138,580 filed on Dec. 18, 2008 and is herein incorporated by reference.

### FIELD OF THE INVENTION

This invention relates to joining of a turbine shaft and a turbine wheel.

### BACKGROUND OF THE INVENTION

Turbochargers may be utilized in an internal combustion engine to compress intake air in order to achieve higher thermal efficiencies, power outputs, torque and fuel economies for the engine. Turbochargers may be utilized in various engines in automotive as well as in aeronautical applications. Generally a turbocharger may include a turbine wheel that rotates at a high velocity such as up to 200,000 rpm. It is powered by exhaust air at elevated temperatures. There is therefore a need to use high temperature materials, especially metals when constructing a turbine wheel. The turbine wheel may be welded to a shaft that is coupled to a compressor wheel. The joining of the shaft to the turbine wheel allows the compressor wheel to rotate within a housing to compress intake air at ambient temperature into a high density and low velocity air known as diffusion. Due to the high rotational velocity it is essential to maintain the balance, axial symmetry and concentricity in an accurate manner as well as provide a high strength joining of the components.

Current prior art turbo charger wheel and shaft may be joined using an inertia friction welding technique in which a shaft may be coupled to a fly wheel that accumulates kinetic energy from rotation at a fixed speed and is forced together with a stationary workpiece such as the turbine wheel. Friction heat is generated to rub the two surfaces together to form a bond. Various limitations included in the inertia friction welding process include the generation of flash coat that must be removed through post welding machining. Additionally, the flash may be trapped inside a cylindrical joint requiring a greater effort to balance the wheel shaft assembly after the joining operation. Further, high thrust pressures in a range of from 2800 kg per cm² requires the use of large, rigid and expensive machinery.

It is additionally known in the prior art to utilize an electron beam welding process to join a turbine wheel and shaft assembly with less post-weld machining and possibly less balancing than inertia friction welding. Electron beam welding utilizes a high power density beam which is focused on a joint in a vacuum. The electron beam produces a deep narrow fusion zone with little weld distortion. Due to high quality weld with little distortion and less work for post-weld machining, EB is often chosen for high stress turbocharger applications. However, electron beam (EB) welding machines typically require a cycle time such as greater than one minute which may further be lengthened if a fixture is used to weld multiple assemblies. Further, EB welding equipment requires high capital investment costs as well as requires the process being carried out in a vacuum.

It is additionally known that gas lasers such as CO₂ lasers and solid state lasers such as Nd:YAG lasers are used in welding torque converters and the like, and can be used for welding a turbine wheel and shaft made of titanium. The CO₂ laser has a wavelength that necessitates the use of expensive helium shielding gas to reduce plasma from material interaction that absorbs the beam power and has poor beam quality (multiple TEM mode). The YAG laser needs an expensive pump (either diode or lamp) with a short life. Both CO₂ and YAG lasers are less energy efficient converting electricity into light.

There is therefore a need in the art for an improved joining process for joining a turbine wheel to a shaft. There is also a need in the art for a joining process that allows high strength and quality joints in an economic manner. Further, there is a need in the art for a welding operation that does not require a vacuum while providing a high strength and accurate joining operation with less post-weld operations.

### SUMMARY OF THE INVENTION

In one aspect there is disclosed a process for joining a turbine wheel and a turbine shaft of a turbocharger comprising the steps of: providing a turbine wheel; providing a turbine shaft; holding the turbine shaft in a welding device; contacting the turbine shaft to the turbine wheel; energizing a pilot current; lifting the shaft a predetermined height from the turbine wheel to draw a pilot arc; energizing a weld arc current locally melting the shaft weld end and forming a weld pool on the wheel; plunging the shaft toward the wheel into the weld pool; turning off the current; and removing the welding device from the welded shaft.

In another aspect there is disclosed a process for joining a turbine wheel and shaft comprising the steps of: providing a turbine wheel; providing a turbine shaft; providing a fiber laser welding device; positioning the turbine shaft relative to the turbine wheel; energizing the fiber laser and passing it about the turbine shaft and the turbine wheel joining the turbine shaft and the turbine wheel.

### BRIEF DESCRIPTION OF THE DRAWINGS

FIG. 1A-F includes side views and sectional views of a turbine wheel and shaft in first and second embodiments of joining processes;

FIG. 2 is a partial sectional view of FIG. 2B;

FIG. 3 is a partial sectional view of FIG. 1F;

FIG. 4 includes a perspective view of a turbine shaft and wheel joined utilizing the process of a first embodiment having a drawn arc welding process and ferrule;

FIG. 5 is a partial perspective view of a shaft and wheel of FIG. 4 following a machining operation of the first embodiment;

FIG. 6 is a partial sectional view of the turbine wheel and shaft following the joining operation of the first embodiment;

FIG. 7 is a perspective view of a turbine wheel and shaft following a bending test of the first embodiment;

FIG. 8 is a partial perspective view detailing the weld joint founed between the shaft and wheel utilizing the second embodiment of the process;

FIG. 9 is a perspective view of a turbine wheel including a pedestal.

### DETAILED DESCRIPTION OF THE PREFERRED EMBODIMENTS

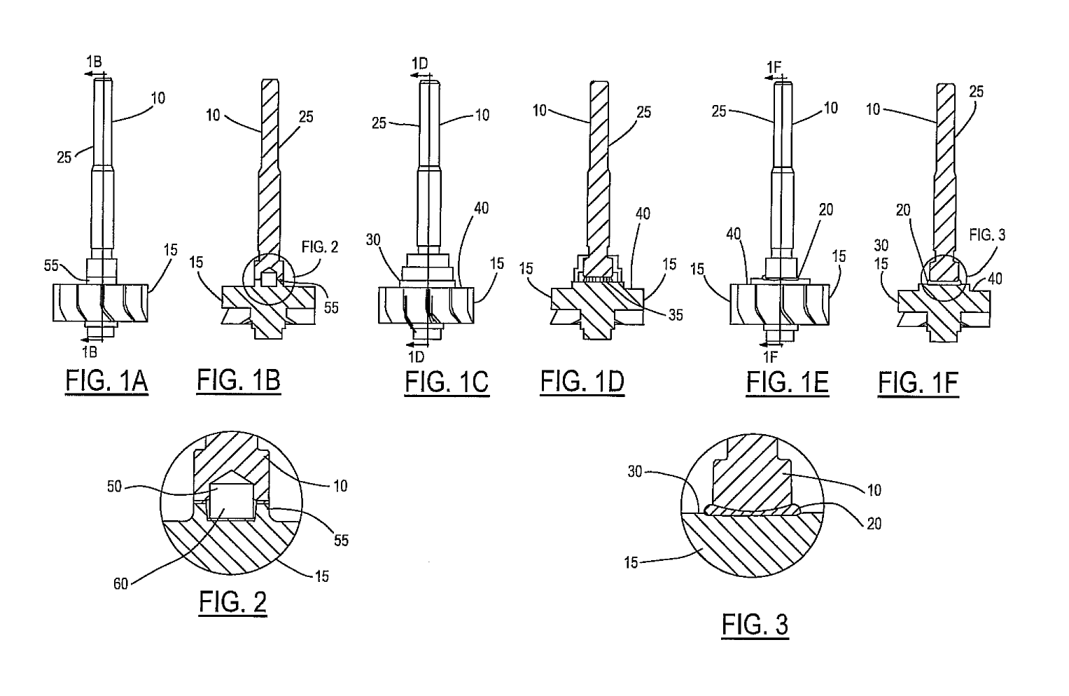

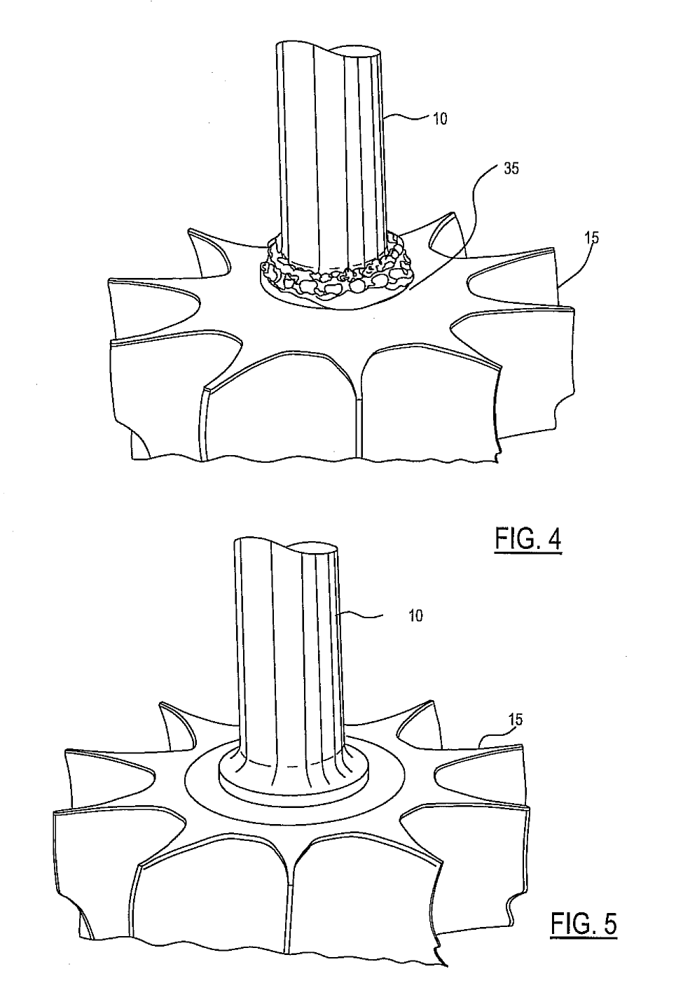

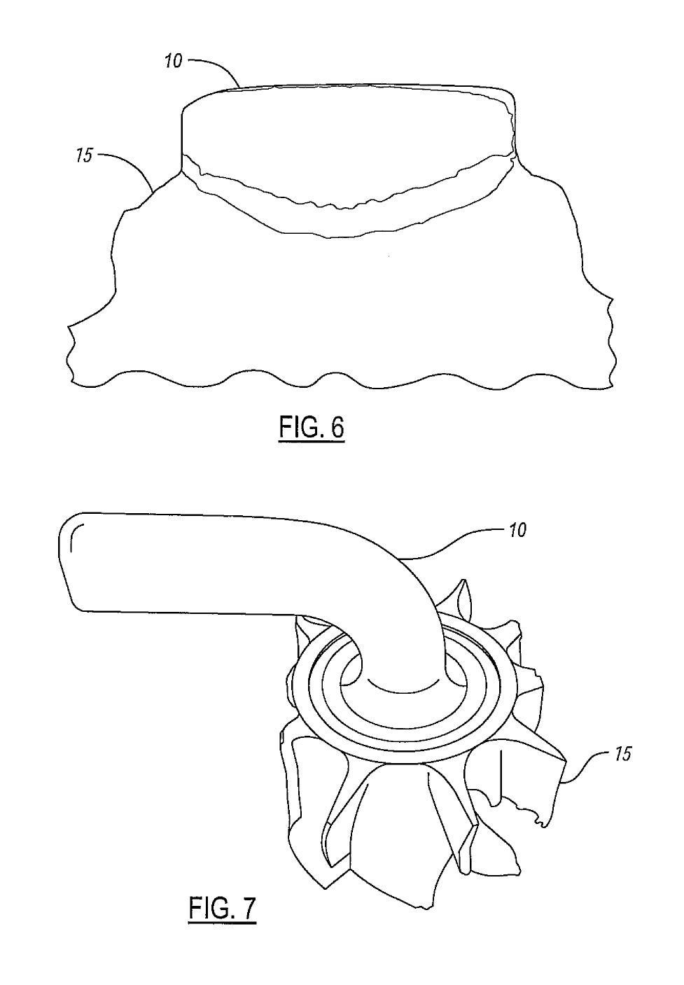

Referring to FIGS. 1-7, there are shown various embodiments of the process for joining a turbine shaft 10 and wheel 15. Referring to FIG. 1 through 5, there is shown a first embodiment for joining a turbine shaft 10 and wheel 15. The first embodiment may include a drawn arc welding process for joining the turbine shaft 10 and wheel 15. The process may include providing a turbine wheel 15 and turbine shaft 10. The turbine shaft 10 may be held in a welding device such as a welding gun or other robotically controlled device. The shaft and turbine wheel 10, 15 are then abutted or contacted with each other. Next a pilot current may be energized in the welding device to flow through the contact between the wheel and the shaft. The shaft 10 is then lifted a predetermined height from the turbine wheel 15 and a pilot arc is energized between the wheel and the shaft. The welding device will then increase the current from low pilot level to a sufficiently high level, creating the main arc locally melting the shaft and wheel 10, 15 forming a weld pool 20. Next the shaft 10 is plunged toward the wheel 15 and into the weld pool 20 and the arc is extinguished. The weld joint formed is allowed to cool and the current is turned off. Lastly the shaft 10 may be removed from the welding device with a weld joint formed between the turbine wheel and shaft 15, 10.

In one aspect, and as detailed in FIGS. 1B-E, the turbine shaft 10 may be a solid rod 25 and the turbine wheel 15 may include a solid abutment 30. As can be seen in the Figures, the abutment 30 may include a ramp like formation 35 formed on a back surface 40 of the turbine wheel 15. In another aspect, the ramp like formations 35 may be replaced by a pedestal 36, best seen in FIG. 9 formed on the turbine wheel 15 which restricts welding heat flow to the wheel. The pedestal 36 may have a top portion 38 having a larger diameter of about 31 mm with a lower shank 42 extending to the turbine wheel 15. The shank 42 may have a diameter of about 15 mm. In this manner a gap 44 of about 3 mm will be formed between the turbine wheel 15 and the top portion 38 of the pedestal 36.

In one aspect, the turbine shaft 10 may be formed of alloy steel such as AISI 8740 steel. The turbine wheel 15 may be formed of a nickel based alloy including the superalloy INCONEL 713. It should be realized that other materials including stainless steel and other nickel based alloys may be utilized for both the turbine wheel and shaft 15, 10.

In one aspect, the first embodiment of the process may include positioning a ferrule 45 about the turbine shaft 10 for containing the weld pool 20, constricting the arc and restricting air from entering the weld area. In such an application, the shaft 10 may also include a flux load formed on the end of the shaft 10 that acts as an oxygen scavenger during the process of the first embodiment,

Additionally, the process of the first embodiment may include the step of removing weld flash utilizing a machine tool following the formation of the weld joint in the drawn arc process. In one aspect, a machining tool may be integrated into the welding device.

Various welding parameters may be utilized for shafts 10 having different outside diameters and profiles. In one aspect, the weld arc current may have a value of from 1,000 to 1,500 amps and may be energized for an arc duration of from 550 to 900 millisecond. In such an application, the process of the first embodiment may join an effective area of 284 mm² and provide a weld joint having a tensile value of above 179 kilonewton; and join an effective area of 198 mm² and provide a weld joint having a tensile value of 100 kilonewton.

In another aspect, the first embodiment may include a step of providing a shielding gas about the portion of the turbine shaft 10 and turbine wheel 15 that are to be joined. The shielding gas may include an inert gas such as argon or an active gas such as mixture containing O₂ or CO₂ and a weld arc current of from 1,100 to 1,500 amps for a duration of from 100 to 150 msec may be utilized. In such an application, a weld joint having an effective area of 127 mm² and having a tensile value of greater than 97 kilonewton may be produced.

In another aspect, the process may include providing a field former that exerts force on the weld arc centering it relative to the turbine shaft 10 and the turbine wheel 15. In this manner, a field former including an electromagnetic coil fed by either the welding current or a separate power supply exerts a force on the arc to bring it back toward the center of the shaft 10. Alternatively, a magnetic field may be created to rotate the arc under the shaft 10 to achieve uniform melting and perpendicularity of the joining of the shaft 10 relative to the wheel 15.

In another aspect, the drawn arc welding process of the first embodiment may include a ring joint design, as shown in FIG. 1B that needs to be maintained during the welding process. Various welding parameters may be utilized for shafts 10 having different outside diameters and profiles. In one aspect, the weld arc current may have a value of about 2000 amps and may be energized for an arc duration of about 400 milliseconds. In such an application, the process of the first embodiment may join an effective area of about 357 mm² and provide a weld joint having a tensile value of about 129 kilonewtons.

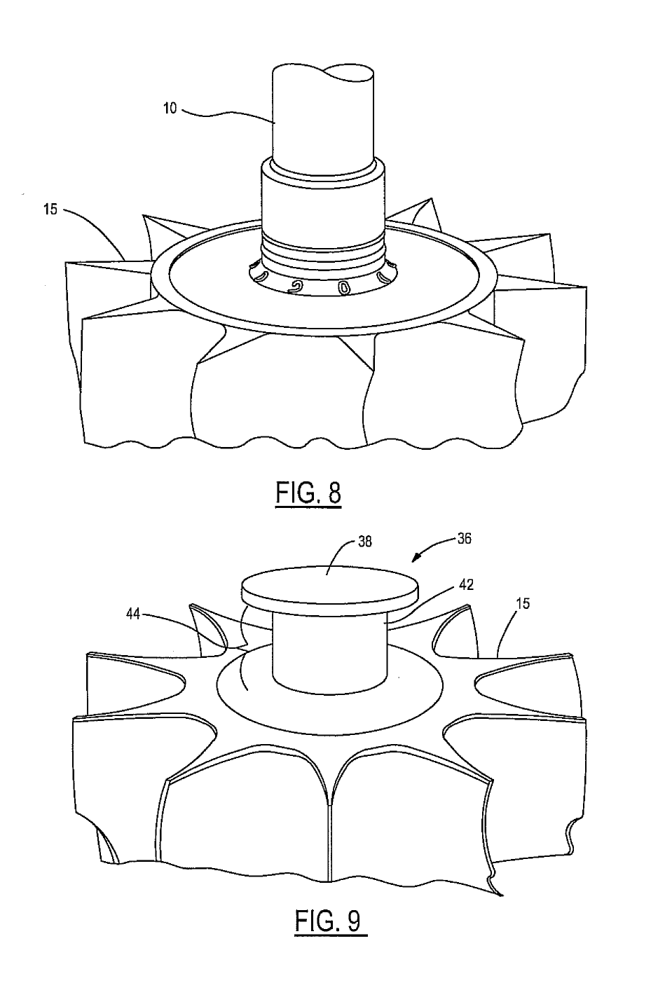

Referring to FIG. 8 there is shown a turbine wheel and shaft 15, 10 joined utilizing a second embodiment of a process. The process of the second embodiment includes providing a turbine wheel 15 and turbine shaft 10. Additionally, a fiber laser welding device is provided. The turbine shaft 10 is positioned relative to the turbine wheel 15, as best shown in FIG. 1A-B. The fiber laser is then energized and passed about the turbine shaft 10 and turbine wheel 15 joining the turbine shaft 10 and the wheel 15. As with the previously described first embodiment, the turbine shaft 10 may be formed of steel including AISI 8740 and the turbine wheel 15 may be formed of a nickel based alloy such as INCONEL 713.

In one aspect, the process of the second embodiment may include providing a shielding gas of Argon about the turbine wheel 15 and shaft 10 when the fiber laser is energized. Additionally, the process for joining the turbine wheel and shaft 15, 10 of the second embodiment may include energizing the fiber laser a second time with a de-focused beam to refine the joint appearance formed between the two components.

In one aspect, the fiber laser may be a Ytterbium laser that has a wave length of 1,070 nm. In one aspect, the fiber laser may include a fiber of 200 μm having a collimator of 100 mm and a focus of 200 mm.

Additionally, the process may include the first energizing step that has a power of 1.5 kw with a rotational speed of 20 rpm with the beam focused on the surface of the shaft and the wheel 10, 15. Further, the second energizing step may include a power of 1.5 kw having a speed of 10 rpm with the beam defocused 20 mm on the surface of the shaft and wheel 10, 15 thereby refining the weld joint appearance.

In one aspect, the second embodiment may include a shaft 10 that is hollow and that has a wall thickness of 3 mm and a diameter of 19 mm. Additionally, the shaft 10 may include a counter bore 50 formed on the end that is to be joined with the turbine wheel 15. Additionally, the wheel 15 may include a raised abutment 55 formed thereon as with the first embodiment. The raised abutment 55 may include a counter bore 60 formed therein. A weld joint formed by the process of the second embodiment may have a tensile value of at least 90 kilonewton.

In one aspect the laser may use a continuous wave or constant power. In another aspect, a periodically fluctuating power may be used to reduce the formation of a welding defect, such as porosity or blow hole. For example a square wave power may be utilized. For example a laser having an average of 1800 W-2000 W, peak-to-peak power of 500 W, 166 Hz frequency sinusoidal waveform, a welding speed of 25 inch per minute, with total weld time of 6 seconds may be utilized. Nitrogen gas at 25 psi may be used in such an operation.

In another aspect, the process of the second embodiment may include welding a cavity shut such as in the depicted embodiment of FIG. 1B. In such an application heated air may become trapped in the cavity and may cause defects such as blow holes. The process may include the step of using the laser in a focused state to drill a small vent hole on the shaft, about 0.2 mm diameter and 3 mm away from the formed joint. The same laser may be used to weld the joint, and then defocused to seal the vent hole.

While specific embodiments of the first and second process have been discussed, it should be realized various power levels, times and parameters may be utilized without departing from the invention.

1. A process for joining a turbine wheel and a turbine shaft of a turbocharger comprising the steps of:
providing a turbine wheel;
providing a turbine shaft;
holding the turbine shaft in a welding device;
contacting the turbine shaft to the turbine wheel;
energizing a pilot current;
lifting the shaft a predetermined height from the turbine wheel to draw a pilot arc;
energizing a weld arc current locally melting the turbine shaft weld end and forming a weld pool on the wheel;
plunging the turbine shaft toward the turbine wheel into the weld pool;
turning off the current;
removing the welding device from the welded turbine shaft.

2. The process for joining a turbine wheel and shaft of claim 1 wherein the turbine shaft weld end is a solid rod.

3. The process for joining a turbine wheel and shaft of claim 1 wherein the turbine wheel includes a solid abutment.

4. The process for joining a turbine wheel and shaft of claim 1 wherein the turbine shaft is formed of steel.

5. The process for joining a turbine wheel and shaft of claim 4 wherein the steel is AISI 8740.

6. The process for joining a turbine wheel and shaft of claim 1 wherein the turbine wheel is formed of a Nickel based superalloy.

7. The process for joining a turbine wheel and shaft of claim 6 wherein the Nickel based alloy is Inconel 713.

8. The process for joining a turbine wheel and shaft of claim 1 including positioning a ferrule about the turbine shaft for containing the weld pool.

9. The process for joining a turbine wheel and shaft of claim 8 wherein the ferrule is selected from the group consisting of: ceramic ferrules, semi-permanent ferrule made of heat-resistant material coated with titanium nitride, boron nitride, or tungsten disulfide, or silver and a semi-permanent ferrule that is water cooled.

10. The process for joining a turbine wheel and shaft of claim 8 including positioning a flux ball at an end of the turbine shaft acting as an oxygen scavenger during the welding process.

11. The process for joining a turbine wheel and shaft of claim 1 including the step of removing weld flash using a machining tool.

12. The process for joining a turbine wheel and shaft of claim 11 wherein the machining tool is integrated into the welding device.

13. The process for joining a turbine wheel and shaft of claim 1 wherein the weld arc current is from 800 to 2500 amps for a duration of from 300 to 1000 milliseconds.

14. The process for joining a turbine wheel and shaft of claim 1 including the step of providing a shielding gas about the portion of the turbine shaft and turbine wheel that are to be joined.

15. The process for joining a turbine wheel and shaft of claim 14 wherein the weld arc current is from 1100 to 2000 amps for a duration of from 80 to 250 milliseconds.

16. The process for joining a turbine wheel and shaft of claim 1 including providing a field former that exerts force on the weld arc centering it relative to the turbine shaft and turbine wheel.

17. A process for joining a turbine wheel and shaft comprising the steps of:
providing a turbine wheel;
providing a turbine shaft;
providing a fiber laser welding device;
positioning the turbine shaft relative to the turbine wheel;
energizing the fiber laser and passing it about the turbine shaft and the turbine wheel joining the turbine shaft and the turbine wheel.

18. The process for joining a turbine wheel and shaft of claim 17 wherein the turbine shaft is formed of steel.

19. The process for joining a turbine wheel and shaft of claim 18 wherein the steel is AISI 8740.

20. The process for joining a turbine wheel and shaft of claim 17 wherein the turbine wheel is formed of a Nickel based superalloy.

21. The process for joining a turbine wheel and shaft of claim 20 wherein the Nickel based superalloy is Inconel 713.

22. The process for joining a turbine wheel and shaft of claim 17 including providing a shielding gas of argon.

23. The process for joining a turbine wheel and shaft of claim 17 including energizing the fiber laser a second cosmetic pass with a de-focused beam without turning off the beam from the first pass.

24. The process for joining a turbine wheel and shaft of claim 17 wherein the fiber laser is a ytterbium laser having a wavelength of 1070 nanometers.

25. The process for joining a turbine wheel and shaft of claim 24 wherein the fiber laser includes a fiber of 200 micrometers a collimator of 100 mm and a focus of 200 mm.

26. The process for joining a turbine wheel and shaft of claim 23 wherein the first energizing step includes a power of 1.5 KW at a speed of 20 rpm with the beam focused on the surface of the turbine shaft and wheel.

27. The process for joining a turbine wheel and shaft of claim 26 wherein the second energizing step includes a power of 1.5 KW at a speed of 20 rpm with the beam defocused 20 mm from the surface of the shaft and wheel.

28. The process for joining a turbine wheel and shaft of claim 17 wherein the shaft is hollow and has a wall thickness of 3 mm and outer diameter of 19 mm.

29. The process for joining a turbine wheel and shaft of claim 17 wherein an end of the shaft includes a counter bore formed therein.

30. The process for joining a turbine wheel and shaft of claim 17 wherein the wheel includes a raised abutment formed thereon, the raised abutment including a counter bore formed therein.

31. The process for joining a turbine wheel and shaft of claim 17 where the fiber laser is time-shared in multiple work cells by beam splitters.

32. The process for joining a turbine wheel and shaft of claim 17 where the fiber laser uses a fluctuating power or a constant power.

33. The process for joining a turbine wheel and shaft of claim 17 including the step of forming a vent in the turbine shaft using the laser prior to joining the turbine shaft and wheel.

34. The process of claim 1 wherein the turbine wheel includes a pedestal formed thereon restricting welding heat flow to the turbine wheel.
